(19) United States
(12) Patent Application Publication
(10) Pub. No.: US 2025/0367625 A1
(43) Pub. Date: Dec. 4, 2025

(54) FIXED BED REACTOR FOR DESULFURIZATION

(71) Applicants: SK INNOVATION CO., LTD., Seoul (KR); SK ENERGY CO., LTD., Seoul (KR)

(72) Inventors: Sun Hyuk BAE, Daejeon (KR); Ho Geun KIM, Seoul (KR); Hyun Ho OH, Seoul (KR)

(21) Appl. No.: 18/963,485

(22) Filed: Nov. 28, 2024

(30) Foreign Application Priority Data
Jun. 3, 2024 (KR) 10-2024-0072180

(51) Int. Cl. B01J 8/02

(52) U.S. Cl. CPC B01J 8/0278; B01J 2208/023

(57) ABSTRACT

A fixed bed reactor for desulfurization is provided, the fixed bed reactor including an outlet collector that is located at a lower end portion of the fixed bed reactor; and a lower baffle that is formed spaced apart from an upper portion of the outlet collector. The fixed bed reactor efficiently lowers a surface temperature of the outlet collector located at a lower end portion of the fixed bed reactor.

### CROSS-REFERENCE TO RELATED APPLICATIONS

This application claims priority under 35 U.S.C. § 119 to Korean Patent Application No. 10-2024-0072180, filed on Jun. 3, 2024, the disclosure of which is incorporated herein by reference in its entirety.

### TECHNICAL FIELD

Embodiments of the present disclosure generally relate to a fixed bed reactor for desulfurization.

### BACKGROUND

Residue hydrodesulfurization (RHDS) is a desulfurization process of reducing a sulfur content in the atmospheric residue (AR) or vacuum residue (VR) obtained from a crude distillation unit (CDU) or a vacuum distillation unit (VDU). The residue hydrodesulfurization promotes the decomposition of sulfur compounds in the residue by applying high pressure and temperature in the presence of hydrogen and a catalyst. Therefore, products that have undergone the residue hydrodesulfurization process have significantly reduced sulfur oxide emissions when burned.

In the residue hydrodesulfurization, an outlet collector is installed below a fixed bed reactor. The outlet collector may support a catalyst bed. In addition, the outlet collector may have a role of filtering out impurities by including a mesh screen or other filtering mechanisms. In this way, solid particles that have not reacted or have fallen out of the catalyst bed are collected, thereby preventing these solid particles from leaving the reactor along with the product stream.

Depending on feed conditions input into the residue hydrodesulfurization, high-temperature coke may occur or hot spots may frequently occur in the catalyst bed of the fixed bed reactor during operation. This may cause the outlet collector to be exposed to high temperature, which may damage a surface of the outlet collector. When the damage to the surface of the outlet collector is accumulated and thus the outlet collector is damaged, the catalyst will leak downstream of the reactor, which will inevitably lead to the shutdown of the process.

Therefore, there is a need to develop a technology of preventing the outlet collector from being exposed to high temperature even if the high-temperature coke or hot spots occur within the catalyst bed of the fixed bed reactor in the residue hydrodesulfurization.

### SUMMARY

Embodiments of the present disclosure overcome the aforementioned issues of the prior art.

An embodiment of the present disclosure may lower a surface temperature of an outlet collector located at a lower end portion of a fixed bed reactor for desulfurization.

An embodiment of the present disclosure may prevent damage to an outlet collector in a fixed bed reactor for desulfurization.

An embodiment of the present disclosure may prevent a catalyst in a fixed bed reactor for desulfurization from leaking downstream from the reactor.

An embodiment of the present disclosure may prevent an operation of residue hydrodesulfurization from suddenly stopping.

An embodiment of the present disclosure may operate residue hydrodesulfurization for a longer period of time and improve the overall economic efficiency of the process.

According to an embodiment of the present disclosure, a fixed bed reactor for desulfurization is provided which includes an outlet collector that is located at a lower end portion of the fixed bed reactor, and a lower baffle that is formed spaced apart from an upper portion of the outlet collector.

The lower baffle may be formed to have a larger area than an upper area of the outlet collector.

The fixed bed reactor may satisfy the following Relational Expression 1.

0.5<D₂/D₁<2 Relational Expression 1

In the above Relational Expression 1, D₁ and D₂ denote a diameter of the outlet collector and a diameter of the lower baffle, respectively.

The fixed bed reactor may satisfy the following Relational Expression 2.

0.1<D₂/D₃<0.9 Relational Expression 2

In the above Relational Expression 2, D₂ and D₃ denote the diameter of the lower baffle and the diameter of the fixed bed reactor, respectively.

The fixed bed reactor may further include an upper baffle formed spaced apart from the upper portion of the lower baffle.

The lower baffle may be formed to have a larger area than the area of the upper baffle.

The fixed bed reactor may satisfy the following Relational Expression 3.

0.2<D₄/D₂<1 Relational Expression 3

In the above Relational Expression 3, D₂ and D₄ denote a diameter of the lower baffle and a diameter of the upper baffle, respectively.

The fixed bed reactor may further include a guide formed on a side portion or upper side portion of the outlet collector.

The guide may include an opening located between the lower baffle and the outlet collector.

The guide may have a shape in which the diameter thereof becomes wider in a downward direction from the opening.

The fixed bed may include a desulfurization catalyst.

The desulfurization catalyst may include a catalyst in which molybdenum-based metal or metal including one or more selected from nickel, cobalt, and tungsten and the molybdenum-based metal are supported on a support.

The support may contain at least one selected from the group consisting of alumina, silica, silica-alumina, titanium oxide, molecular sieve, zirconia, aluminum phosphate, carbon, and niobia.

The outlet collector may include a mesh.

According to an embodiment, a fixed bed reactor for desulfurization atmospheric residue or vacuum residue obtained from a crude distillation unit or a vacuum distillation unit, the fixed bed reactor comprising: an outlet collector that is located at a lower end portion of the fixed bed reactor; and a lower baffle spaced apart from an upper portion of the outlet collector; a guide formed on a side portion or upper side portion of the outlet collector, the guide including an opening located between the lower baffle and the outlet collector; and a desulfurization catalyst.

### BRIEF DESCRIPTION OF THE DRAWINGS

FIG. 1 is a cross-sectional view of a fixed bed reactor according to Example 1 of the present disclosure.

FIG. 2 is a cross-sectional view of a fixed bed reactor according to Example 2 of the present disclosure.

FIG. 3 is a cross-sectional view of a fixed bed reactor according to Example 3 of the present disclosure.

FIG. 4 is a perspective view of a fixed bed reactor according to Example 3 of the present disclosure.

FIG. 5 is a cross-sectional view of a fixed bed reactor according to Example 4 of the present disclosure.

FIG. 6 is a perspective view of a fixed bed reactor according to Example 4 of the present disclosure.

FIG. 7 is a cross-sectional view of a fixed bed reactor according to Example 5 of the present disclosure.

FIG. 8 is a perspective view of a fixed bed reactor according to Example 5 of the present disclosure.

FIG. 9 is a cross-sectional view of a fixed bed reactor according to Example 6 of the present disclosure.

FIG. 10 is a cross-sectional view of a fixed bed reactor according to Example 7 of the present disclosure.

FIG. 11 is a perspective view of a fixed bed reactor according to Example 7 of the present disclosure.

FIG. 12 is a cross-sectional view of a fixed bed reactor according to Example 8 of the present disclosure.

FIG. 13 is a perspective view of a fixed bed reactor according to Example 8 of the present disclosure.

FIG. 14 is a cross-sectional view of a fixed bed reactor according to Example 9 of the present disclosure.

### DETAILED DESCRIPTION

Various advantages and features of the embodiments of the present disclosure and methods accomplishing them will become apparent from the following description of the embodiments. However, the embodiments of the present disclosure are not limited to embodiments disclosed below, and may be implemented in various different forms, these embodiments will be provided only in order to make the present disclosure complete and allow one of ordinary skill in the art to which the present disclosure pertains to completely recognize the scope of the present disclosure. Moreover, the embodiments of the present disclosure will be defined by the scope of the claims.

Unless defined otherwise, all terms (including technical and scientific terms) used in the present specification have the same meaning as meanings commonly understood by those skilled in the art to which the present disclosure pertains.

A singular form of the term used herein may be construed to include a plural form unless otherwise indicated.

Numerical ranges as used herein include all possible combinations of lower and upper limits and all values within that range, increments logically derived from the form and width of the defined ranges, all values defined herein, and upper and lower limits of numerical ranges defined in different forms. Unless specifically defined otherwise herein, values outside the numerical ranges that may occur due to experimental errors or rounding of values are also included in the defined numerical ranges.

“Including” mentioned herein is an open-ended description having an equivalent meaning to expressions such as “comprising”, “containing”, “having”, “characterizing”, and elements, materials, or processes not listed additionally are not excluded.

Unless specifically stated herein, the unit of % used means % by weight.

In this specification, “A to B” means “A or more and B or less” unless otherwise specifically defined.

In the present disclosure, the term “residue” may refer to oil having a boiling point of 300° C. or higher, which remains after light oil or gas having a low boiling point is separated in a crude distillation unit (CDU) or a vacuum distillation unit (VDU).

In the present disclosure, the term “heavy oil” may refer to oil having American Petroleum Institute gravity (API gravity) of 30° C. or lower as defined by the American Petroleum Institute.

Hereinafter, a fixed bed reactor of the present disclosure will be described in detail. However, this is merely illustrative, and the embodiments of the present disclosure are not limited to the specific embodiments described herein.

The present disclosure relates to a fixed bed reactor for desulfurization. The fixed bed reactor for desulfurization includes an outlet collector that is located at a lower end portion of the fixed bed reactor; and a lower baffle that is formed spaced apart from an upper portion of the outlet collector.

The fixed bed reactor according to an embodiment of the present disclosure includes the lower baffle formed above the outlet collector located at a lower end portion of the fixed bed reactor, so that a high-temperature stream due to a hot spot does not directly fall and the time for heat exchange with a low-temperature stream may increase. Therefore, surface temperature of the outlet collector may be lowered.

In addition, the lower baffle is formed above the outlet collector, thereby preventing damage to the outlet collector. In addition, a catalyst in the fixed bed reactor may be prevented from leaking downstream from the reactor. Accordingly, a sudden operation stop of a hydrodesulfurization process may be prevented, so that the stability of the process operation may be improved. In addition, the hydrodesulfurization process may be operated for a longer period of time, which may improve the economic efficiency of the process.

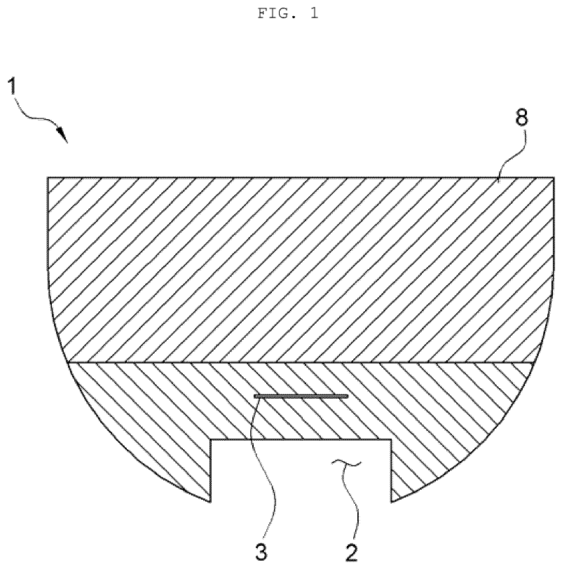

Referring to FIG. 1, an embodiment of the present disclosure relates to a fixed bed reactor 1 for desulfurization including an outlet collector 2 that is located at a lower end portion of the fixed bed reactor 1, and a lower baffle 3 that is spaced apart from an upper portion of the outlet collector 2. A fixed bed 8 including a catalyst may be located above the lower baffle 3.

The lower baffle 3 may be supported by a support extending from the outlet collector, but is not limited thereto. The number of supports may be 2 or more, 4 or more, 8 or more, 10 or less, 6 or less, 4 or less, 3 or less, or have a value between the above numbers, but the number of supports is not limited thereto.

The fixed bed reactor for desulfurization may be for desulfurization of heavy oil or residue, but the fixed bed reactor is not limited thereto, and may also be used for desulfurization of general oil.

In another embodiment of the present disclosure, the lower baffle may be formed to have a larger area than an upper area of the outlet collector. When the lower baffle is formed to have a larger area than the upper area of the outlet collector, the lower baffle may cover the entire upper area of the outlet collector. Therefore, since a high-temperature stream is prevented from contacting the outlet collector due to the high-temperature stream directly falling from the hot spot, the surface temperature of outlet collector can be lowered.

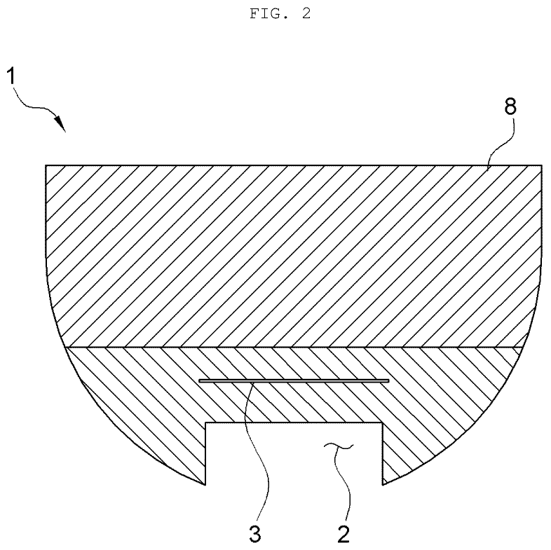

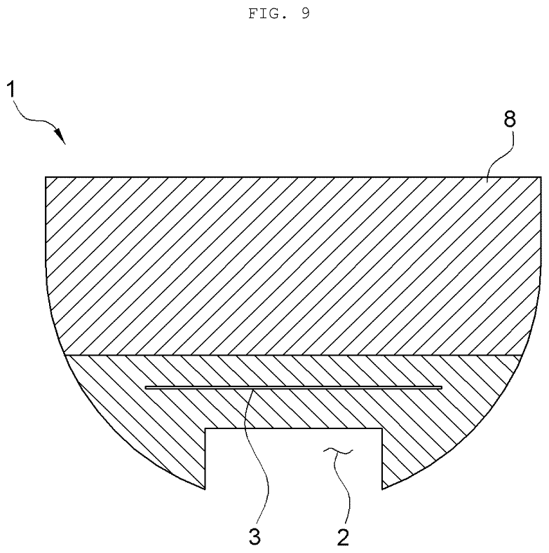

Referring to FIGS. 2 and 9, the outlet collector 2 may be located at the lower end portion of the fixed bed reactor 1. The lower baffle 3 may be formed spaced apart from the upper portion of the outlet collector 2. The fixed bed 8 including the catalyst may be located above the lower baffle 3. The lower baffle 3 is formed to have a larger area than the upper area of the outlet collector 2.

In an embodiment of the present disclosure, the fixed bed reactor may satisfy the following Relational Expression 1.

$$0.5 < {D}_{2} / {D}_{1} < 2 \qquad Relational Expression 1$$

In the above Relational Expression 1, D₁ and D₂ denote a diameter of the outlet collector and a diameter of the lower baffle, respectively.

The above Relational Expression 1 may specifically be 1<D₂/D₁<2 or 1.5<D₂/D₁<2, but is not limited thereto. When the above Relational Expression 1 satisfies the above ranges, the temperature of the outlet collector may be efficiently lowered. In another embodiment of the present disclosure, the fixed bed reactor may satisfy the following Relational Expression 2.

$$0.1 < {D}_{2} / {D}_{3} < 0.9 \qquad Relational Expression 2$$

In the above Relational Expression 2, D₂ and D₃ denote a diameter of the lower baffle and a diameter of the fixed bed reactor, respectively.

The above Relational Expression 1 may specifically be 0.2<D₂/D₃<0.9 or 0.4<D₂/D₃<0.9, but is not limited thereto. When the above Relational Expression 2 satisfies the above ranges, the temperature of the outlet collector may be efficiently lowered.

In an embodiment of the present disclosure, the fixed bed reactor may further include a guide formed on a side portion or upper side portion of the outlet collector. In addition, the guide may include an opening located between the lower baffle and the outlet collector.

When the fixed bed reactor includes the guide including the opening, heat exchange between the high-temperature stream from the hot spot and a relatively low-temperature stream may occur smoothly. Therefore, it is possible to efficiently lower the temperature of the outlet collector.

In an embodiment of the present disclosure, the guide may be a shape in which the diameter thereof becomes wider as it goes upward from the opening. In addition, the guide may be fixed to a wall of the fixed bed reactor. It is natural that the guide may be installed to be inclined with respect to the ground. When the guide is installed in the fixed bed reactor, the temperature of the outlet collector may be lowered.

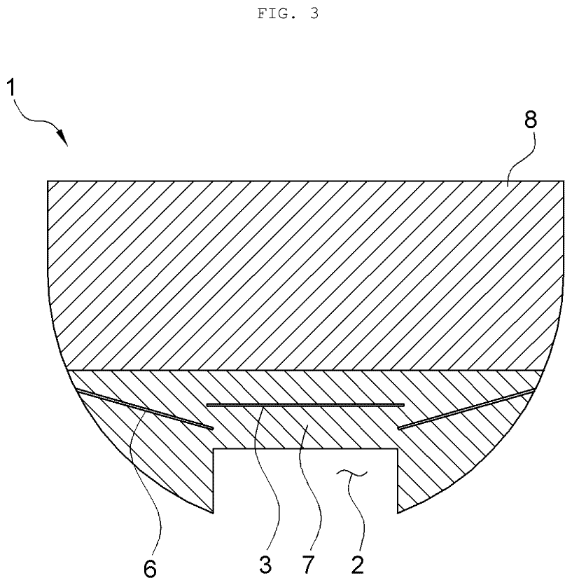

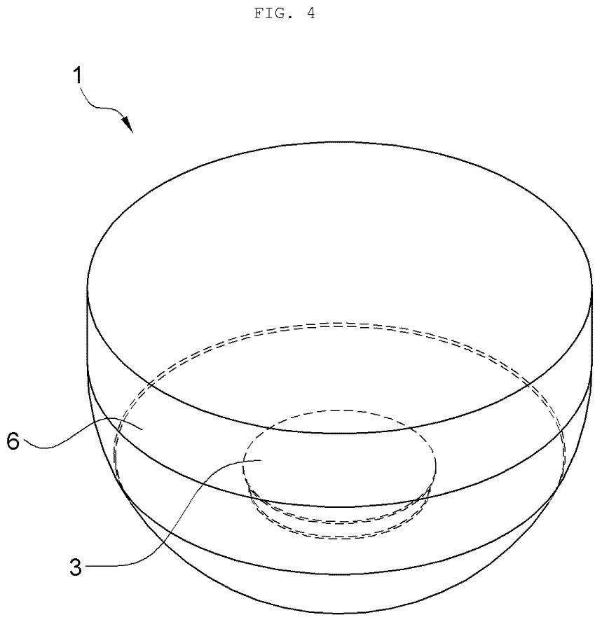

Referring to FIGS. 3 and 4, the outlet collector 2 may be located at the lower end portion of the fixed bed reactor 1. The lower baffle 3 may be formed spaced apart from the upper portion of the outlet collector 2. The fixed bed 8 including the catalyst may be located above the lower baffle 3. The lower baffle 3 is formed to have a larger area than the upper area of the outlet collector 2. The fixed bed reactor may further include a guide 6 formed on the side portion or upper side portion of the outlet collector 2. In addition, the guide 6 may include an opening 7 located between the lower baffle 3 and the outlet collector 2. The guide 6 may be formed in the shape in which the diameter thereof becomes wider as it goes upward from the opening 7.

According to an embodiment of the present disclosure, the guide 6 may be installed to be inclined 5 to 45° or 10 to 30° with respect to the ground, but is not limited thereto.

In another embodiment according to the present disclosure, the guide may be formed in a horizontal direction from the opening. In addition, the guide may be fixed to a wall of the fixed bed reactor. It is natural that the guide may be installed horizontally with respect to the ground. When the guide is installed in the fixed bed reactor, the temperature of the outlet collector 2 may be lowered.

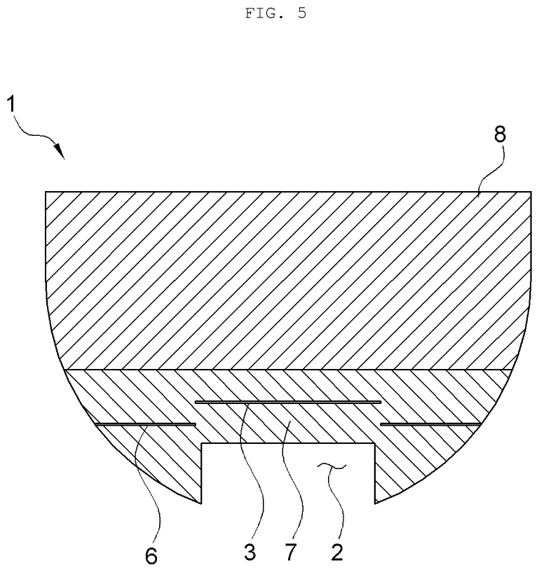

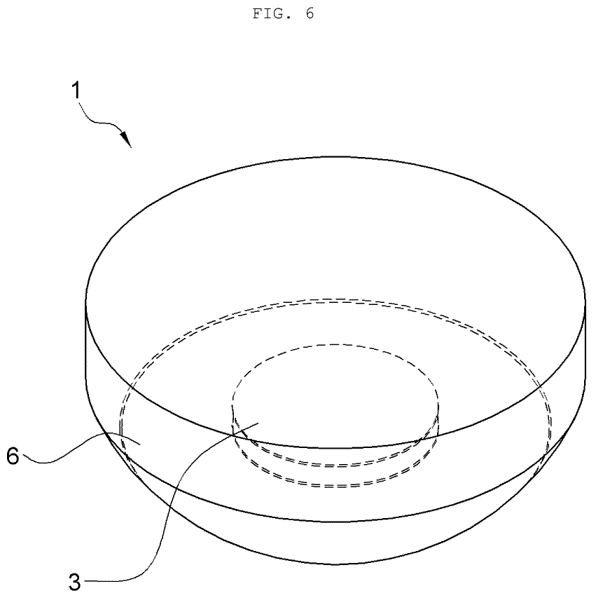

Referring to FIGS. 5 and 6, the outlet collector 2 may be located at the lower end portion of the fixed bed reactor 1. The lower baffle 3 may be formed spaced apart from the upper portion of the outlet collector 2. The fixed bed 8 including the catalyst may be located above the lower baffle 3. The lower baffle 3 is formed to have a larger area than the upper area of the outlet collector 2. The fixed bed reactor may further include the guide 6 formed on the side portion or upper side portion of the outlet collector 2. In addition, the guide may include an opening 7 located between the lower baffle and the outlet collector. The guide 6 may be formed in a horizontal direction from the opening 7.

In an embodiment of the present disclosure, the guide 6 may have a shape in which the diameter thereof becomes wider as it goes downward from the opening. In addition, the guide may be fixed to a wall of the fixed bed reactor. It is natural that the guide may be installed to be inclined with respect to the ground. When the guide is installed in the fixed bed reactor, the temperature of the outlet collector may be lowered.

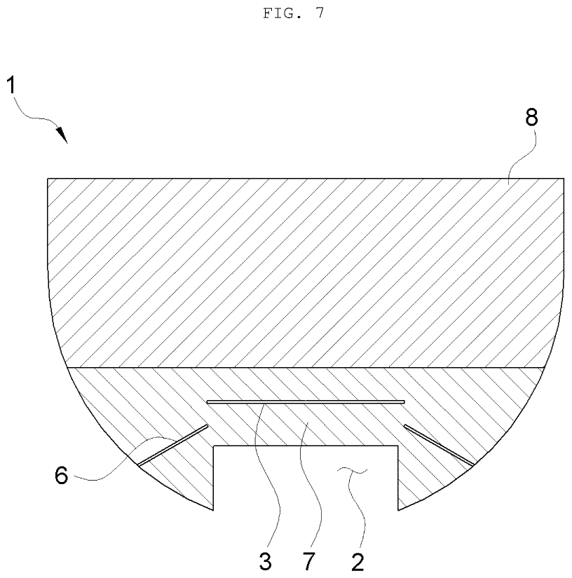

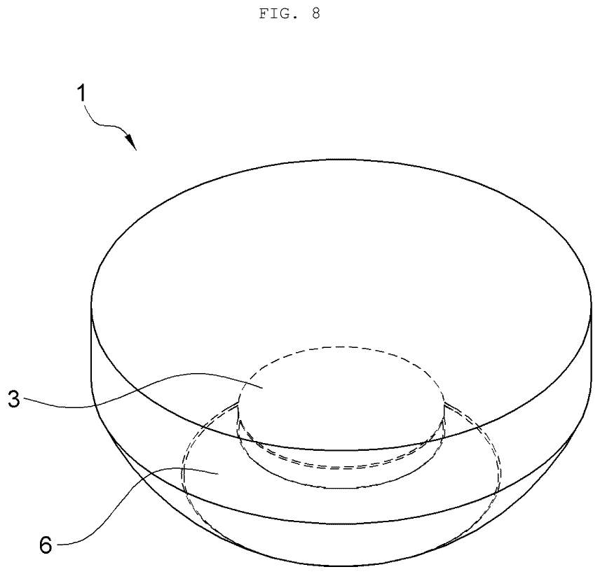

Referring to FIGS. 7 and 8, the outlet collector 2 may be located at the lower end portion of the fixed bed reactor 1. The lower baffle 3 may be formed spaced apart from the upper portion of the outlet collector 2. The fixed bed 8 including the catalyst may be located above the lower baffle 3. The lower baffle 3 is formed to have a larger area than the upper area of the outlet collector 2. The fixed bed reactor may further include a guide 6 formed on the side portion or upper side portion of the outlet collector 2. In addition, the guide may include an opening 7 located between the lower baffle and the outlet collector. The guide 6 may be formed in the shape in which the diameter thereof becomes wider as it goes downward from the opening 7.

According to an embodiment of the present disclosure, the guide may be installed to be inclined 5 to 45° or 10 to 35° with respect to the ground, but is not limited thereto.

According to an embodiment of the present disclosure, the fixed bed reactor may further include a lowermost baffle formed spaced apart from the lower portion of the lower baffle, but is not limited thereto. By forming the lowermost baffle spaced apart from the lower portion of the lower baffle, it is possible to more efficiently lower the temperature of the outlet collector 2. The lowermost baffle may be supported by a support connected from the center of the lower baffle. The lowermost baffle may be supported by a support extending from the outlet collector.

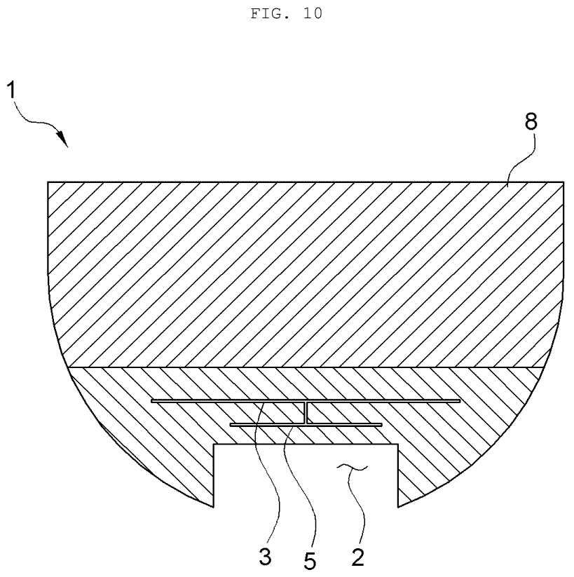

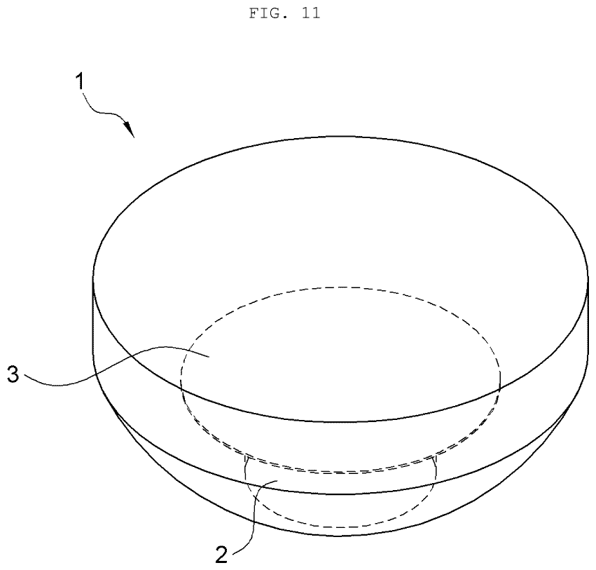

Referring to FIGS. 10 and 11, the outlet collector 2 may be located at the lower end portion of the fixed bed reactor 1. The lower baffle 3 may be formed spaced apart from the upper portion of the outlet collector 2. The fixed bed 8 including the catalyst may be located above the lower baffle 3. The lower baffle 3 is formed to have a larger area than the upper area of the outlet collector 2. The fixed bed reactor may further include a lowermost baffle 5 formed spaced apart from the lower portion of the lower baffle.

The lowermost baffle may be formed to have a smaller area than the area of the lower baffle, but is not limited thereto.

According to an embodiment of the present disclosure, the fixed bed reactor may further include an upper baffle formed spaced apart from the upper portion of the lower baffle, but is not limited thereto. By forming the upper baffle above the lower baffle, it is possible to more efficiently lower the temperature of the outlet collector. The upper baffle may be supported by a support connected from the center of the lower baffle, but is not limited thereto.

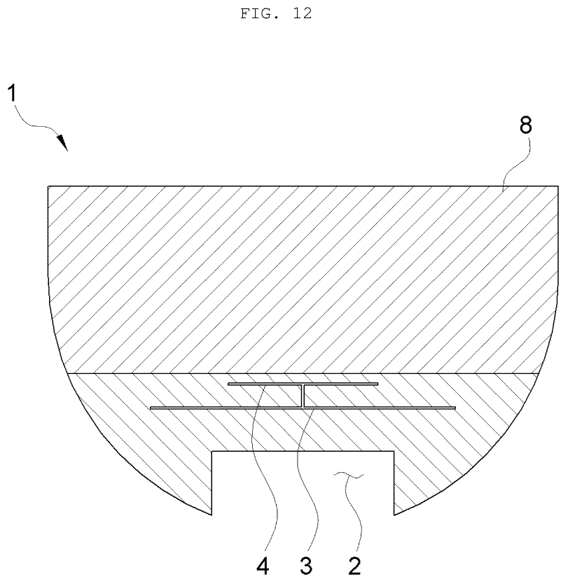

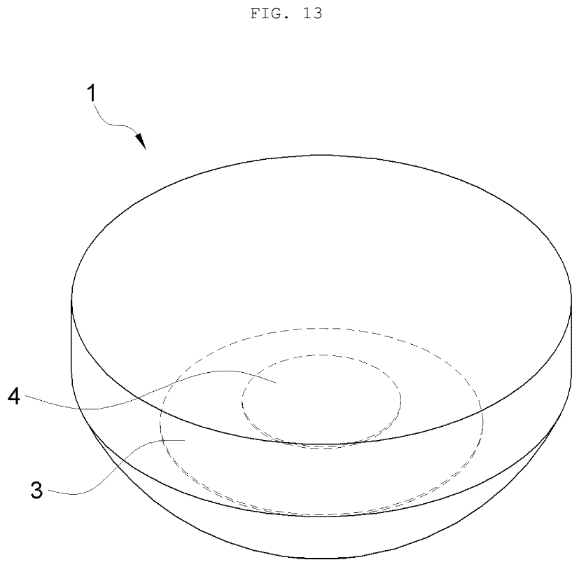

Referring to FIGS. 12 and 13, the outlet collector 2 may be located at the lower end portion of the fixed bed reactor 1. The lower baffle 3 may be formed spaced apart from the upper portion of the outlet collector 2. The fixed bed 8 including the catalyst may be located above the lower baffle 3. The lower baffle 3 is formed to have a larger area than the upper area of the outlet collector 2. The fixed bed reactor may further include an upper baffle 4 formed spaced apart from the upper portion of the lower baffle 3.

In an embodiment according to the present disclosure, the lower baffle 3 may be formed with a larger area than the area of the upper baffle.

In addition, in another embodiment of the present disclosure, the fixed bed reactor may satisfy the following Relational Expression 3.

$$0.2 < {D}_{4} / {D}_{2} < 1 \qquad Relational Expression 3$$

In the above Relational Expression 3, D₂ and D₄ denote a diameter of the lower baffle and a diameter of the upper baffle, respectively.

The above Relational Expression 3 may specifically be 0.4<D₄/D₂<1 or 0.6<D₄/D₂<1, but is not limited thereto. The fixed bed reactor may efficiently lower the temperature of the outlet collector when it satisfies the above Relational Expression 3.

In an embodiment according to the present disclosure, the fixed bed reactor may further include an upper baffle formed spaced apart from the upper portion of the lower baffle; and a guide formed on the side portion or upper side portion of the outlet collector, in which the guide may include an opening located between the lower baffle and the outlet collector, and the guide may have a shape in which a diameter thereof becomes wider as it goes upward from the opening, may be formed horizontally from the opening, or may have a shape in which a diameter thereof becomes wider as it goes downward from the opening. Since the fixed bed reactor includes all of the upper baffle, the lower baffle, and the guide, the surface temperature of the outlet collector may be maintained low.

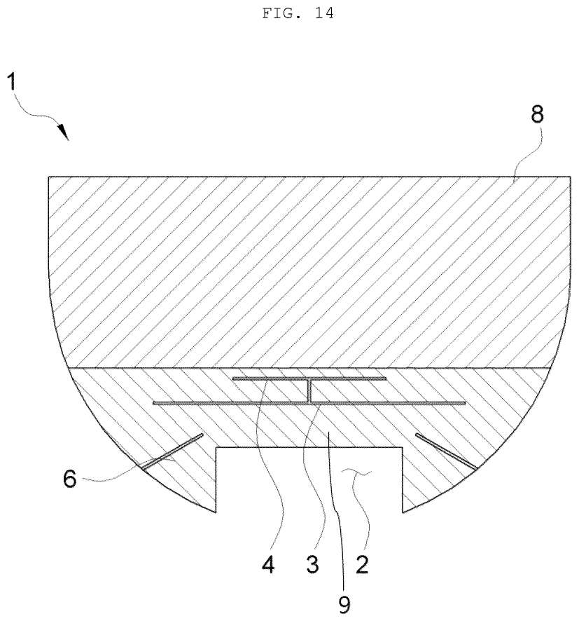

Referring to FIG. 14, the outlet collector 2 may be located at the lower end portion of the fixed bed reactor 1. The lower baffle 3 may be formed spaced apart from the upper portion of the outlet collector 2. The fixed bed 8 including the catalyst may be located above the lower baffle 3. The lower baffle 3 is formed to have a larger area than the upper area of the outlet collector 2. The fixed bed reactor may further include the guide 6 formed on the side portion or upper side portion of the outlet collector 2. In addition, the guide may include the opening 9 located between the lower baffle 3 and the outlet collector 2. The guide 6 may be formed in the shape in which the diameter thereof becomes wider as it goes downward from the opening. The fixed bed reactor may further include an upper baffle 4 formed spaced apart from the upper portion of the lower baffle 3.

In an embodiment according to the present disclosure, the fixed bed may include a desulfurization catalyst, but is not limited thereto. The fixed bed may include a single type of catalyst. In addition, the fixed bed may include a mixture of at least two or more different types of catalysts. In addition, the fixed bed may include a first catalyst bed and a second catalyst bed including a catalyst different from the first catalyst bed. The fixed bed may further include a third catalyst bed, but is not limited thereto.

In an embodiment of the present disclosure, the desulfurization catalyst may include a catalyst in which molybdenum-based metal or metal including one or more selected from nickel, cobalt, and tungsten and the molybdenum-based metal are supported on a support, but is not limited thereto.

In an embodiment of the present disclosure, the support may contain at least one selected from the group consisting of alumina, silica, silica-alumina, titanium oxide, molecular sieve, zirconia, aluminum phosphate, carbon, and niobia, but is not limited thereto.

The space of the fixed bed reactor that is not filled with the catalyst may be filled with inert balls, but is not limited thereto. The inert balls may be filled in the space where the catalyst is not filled to adjust the height of the fixed bed or may be filled to maintain the fixed bed at a constant height.

In an embodiment of the present disclosure, the outlet collector may include a mesh, however, it is noted that the outlet collector may not be limited in this way. The outlet collector may perform a function of filtering out impurities by including the mesh. In this way, the solid particles that have not reacted or have fallen out of the catalyst bed may be collected, thereby preventing these solid particles from leaving the reactor along with the product stream.

Hereinafter, embodiments of the present disclosure will be further described with reference to specific Experimental Examples. The Examples and the Comparative Examples are merely illustrative of the embodiments of the present disclosure and are not intended to limit the scope of the present disclosure as defined in the appended claims. It will be apparent to those skilled in the art that various changes and modifications to the described Examples are possible within the scope and technical concepts of the present disclosure, and that such changes and modifications fall within the scope of the appended claims.

### Example 1

A fixed bed reactor was measured to have a diameter of 4.4 m, a total height of 11.4 m, and a height of 7 m from a lower tangent line to an upper tangent line.

A catalyst in which nickel and cobalt were supported on alumina in the fixed bed reactor was filled with a filling height of 6.25 m in a fixed bed. An upper space and a lower space of a catalyst bed, which were not filled with the catalyst, were filled with inert balls.

An outlet collector including a mesh was located at a lower end of the fixed bed reactor. A diameter of the outlet collector was measured to be 1.45 m. A lower baffle was formed spaced 0.4 m upward from the top of the outlet collector. The lower baffle has a disk shape, and a diameter of the disk was measured to be 0.8 m and a thickness of the disk was measured to be 0.005 m. This was illustrated in detail in FIG. 1.

25,000 kg/hr of atmospheric residue (AR) was fed into the fixed bed reactor. In addition, 5,000 kg/hr of hydrogen was fed into the fixed bed reactor. The fixed bed reactor was operated under temperature and pressure conditions of 350° C. and 150 bar,g.

A surface temperature of the outlet collector was measured through a thermocouple attached to an upper center of the outlet collector. The measured surface temperature of the outlet collector was shown in Table 1 below.

### Example 2

Example 2 was performed under the same conditions as in Example 1, except that the diameter of the lower baffle plate was 1.6 m. This was illustrated in detail in FIG. 2. The measured surface temperature of the outlet collector was shown in Table 1 below.

### Example 3

Example 3 was performed under the same conditions as in Example 2, except that the fixed bed reactor includes a guide formed on an upper side portion of the outlet collector. The guide included an opening with a diameter of 1.5 m located between the lower baffle and the outlet collector, and was formed in a shape in which the diameter thereof became wider as it went upward from the opening. The guide was fixed to the wall of the fixed bed reactor to be spaced 0.6 m upward from the top of the outlet collector and was installed to be inclined 20° with respect to the ground. This was illustrated in detail in FIGS. 3 and 4. The measured surface temperature of the outlet collector was shown in Table 1 below.

### Example 4

Example 4 was performed under the same conditions as in Example 2, except that the fixed bed reactor includes a guide formed on an upper side portion of the outlet collector. The guide was formed by including an opening having a diameter of 1.5 m located between the lower baffle and the outlet collector. The guide was fixed to the wall of the fixed bed reactor to be spaced 0.2 m upward from the top of the outlet collector and was formed in a horizontal direction from the opening. This was illustrated in detail in FIGS. 5 and 6. The measured surface temperature of the outlet collector was shown in Table 1 below.

### Example 5

Example 5 was performed under the same conditions as in Example 2, except that the fixed bed reactor includes a guide formed on a side portion of the outlet collector. The guide included an opening with a diameter of 1.5 m located between the lower baffle and the outlet collector, and was formed in a shape in which the diameter thereof becomes wider as it goes downward from the opening. The guide was fixed to the wall of the fixed bed reactor to be spaced 0.2 m downward from the top of the outlet collector and was installed to be inclined 30° with respect to the ground. This was illustrated in detail in FIGS. 7 and 8. The measured surface temperature of the outlet collector was shown in Table 1 below.

### Example 6

Example 6 was performed under the same conditions as in Example 1, except that the diameter of the lower baffle plate was 2.4 m. This was illustrated in detail in FIG. 9. The measured surface temperature of the outlet collector was shown in Table 1 below.

### Example 7

Example 7 was performed under the same conditions as in Example 1, except that, the fixed bed reactor was formed spaced apart from a lower portion of the lower baffle by 0.2 m, had a disk shape, and further included the lowermost baffle with a disk diameter of 1.3 m. This was illustrated in detail in FIGS. 10 and 11. The measured surface temperature of the outlet collector was shown in Table 1 below.

### Example 8

Example 8 was performed under the same conditions as in Example 1, except that, the fixed bed reactor was formed 0.2 m apart from an upper portion of the lower baffle, had a disk shape, and further included an upper baffle with a disk diameter of 1.3 m. This was illustrated in detail in FIGS. 12 and 13. The measured surface temperature of the outlet collector was shown in Table 1 below.

### Example 9

Example 9 was performed under the same conditions as in Example 8, except that the fixed bed reactor includes a guide formed on a side portion of the outlet collector. The guide included an opening with a diameter of 1.5 m located between the lower baffle and the outlet collector, and was formed in a shape in which the diameter thereof became wider as it went downward from the opening. The guide was fixed to the wall of the fixed bed reactor to be spaced 0.2 m downward from the top of the outlet collector and was installed to be inclined 30° with respect to the ground. This was illustrated in detail in FIG. 14. The measured surface temperature of the outlet collector was shown in Table 1 below.

### Comparative Example 1

Comparative Example 1 was performed under the same conditions as in Example 1, except that in the comparative Example 1 the lower baffle was not installed in the fixed bed reactor. The measured surface temperature of the outlet collector was shown in Table 1 below.

TABLE 1

| | Surface temperature of outlet |
|---|---|
| | collector (° C.) |
| Comparative Example 1 | 1062 |
| Example 1 | 991 |
| Example 2 | 893 |
| Example 3 | 802 |
| Example 4 | 790 |
| Example 5 | 772 |
| Example 6 | 845 |
| Example 7 | 793 |
| Example 8 | 760 |
| Example 9 | 742 |

In Comparative Example 1 where the lower baffle was not installed in the fixed bed reactor, the surface temperature of the outlet collector was measured at 1062° C.

In Example 1 where the lower baffle was installed to have a diameter of 0.8 m, the surface temperature of the outlet collector was measured at 991° C., so it was confirmed that the surface temperature of the outlet collector was lower than in Comparative Example 1.

In Example 2 where the lower baffle was installed to have a diameter of 1.6 m and the lower baffle was formed to have a larger area than an upper area of the outlet collector, the surface temperature of the outlet collector was measured at 893° C.

In Example 3 where the lower baffle had a diameter of 1.6 m and the guide formed in the shape in which the diameter thereof became wider as it went upward from the opening is installed, the surface temperature of the outlet collector was measured at 802° C.

In Example 4 where the lower baffle had a diameter of 1.6 m and the guide formed in a horizontal direction from the opening was installed, the surface temperature of the outlet collector was measured at 790° C.

In Example 5 where the lower baffle had a diameter of 1.6 m and the guide formed in the shape in which the diameter thereof became wider as it went downward from the opening was installed, the surface temperature of the outlet collector was measured at 772° C. Namely, it showed the best outlet collector surface temperature among the examples in which the lower baffle had a diameter of 1.6 m.

In Example 6 where the lower baffle had a diameter of 2.4 m, the surface temperature of the outlet collector was measured at 845° C., so it was confirmed that the surface temperature of the outlet collector was lowered more than in Example 2 where the lower baffle having a diameter of 1.6 m was installed.

In Example 7 where the lower baffle had a diameter of 2.4 m and the lower baffle and the lowermost baffle were installed, the surface temperature of the outlet collector was measured at 793° C.

In Example 8 where the lower baffle had a diameter of 2.4 m and the upper baffle and the lower baffle were installed, the surface temperature of the outlet collector was measured at 760° C.

In Example 9 where the lower baffle had a diameter of 2.4 m, the upper baffle and the lower baffle were installed, and the guide in the shape in which the diameter thereof became wider as it went downward from the opening was provided, the surface temperature of the outlet collector was measured to be 742° C., indicating the lowest surface temperature of the outlet collector.

According to the fixed bed reactor for desulfurization of the present disclosure, it is possible to lower the surface temperature of the outlet collector located at a lower end portion of the fixed bed reactor for desulfurization.

According to the fixed bed reactor for desulfurization of the present disclosure, it is possible to prevent the damage to the outlet collector in the fixed bed reactor for desulfurization.

According to the fixed bed reactor for desulfurization of the present disclosure, it is possible to prevent the catalyst in the fixed bed reactor for desulfurization from leaking downstream from the reactor.

According to the fixed bed reactor for desulfurization of the present disclosure, it is possible to prevent the operation of the residue hydrodesulfurization from suddenly stopping.

According to the fixed bed reactor for desulfurization of the present disclosure, it is possible to operate the residue hydrodesulfurization for a longer period of time to improve the economic efficiency of the process.

The above-described embodiments are merely examples of applying the principles of the present disclosure, and other embodiments may be further included without departing from the scope of the present disclosure. Furthermore, the embodiments may be combined to form additional embodiments.

What is claimed is:

1. A fixed bed reactor for desulfurization, comprising:
an outlet collector that is located at a lower end portion of the fixed bed reactor; and
a lower baffle spaced apart from an upper portion of the outlet collector.

2. The fixed bed reactor of claim 1, wherein the lower baffle is formed to have a larger area than an upper area of the outlet collector.

3. The fixed bed reactor of claim 1, wherein the fixed bed reactor satisfies the following Relational Expression 1,
0.5<D₂/D₁<2, and Relational Expression 1
wherein in the above Relational Expression 1, D₁ and D₂ denote a diameter of the outlet collector and a diameter of the lower baffle, respectively.

4. The fixed bed reactor of claim 1, wherein the fixed bed reactor satisfies the following Relational Expression 2,
0.1<D₂/D₃<0.9, and Relational Expression 2
wherein in the above Relational Expression 2, D₂ and D₃ denote a diameter of the lower baffle and a diameter of the fixed bed reactor, respectively.

5. The fixed bed reactor of claim 1, further comprising an upper baffle formed spaced apart from the upper portion of the lower baffle.

6. The fixed bed reactor of claim 5, wherein the lower baffle is formed to have a larger area than an area of the upper baffle.

7. The fixed bed reactor of claim 6, wherein the fixed bed reactor satisfies the following Relational Expression 3,
0.2<D₄/D₂<1, and Relational Expression 3
wherein in the above Relational Expression 3, D₂ and D₄ denote a diameter of the lower baffle and a diameter of the upper baffle, respectively.

8. The fixed bed reactor of claim 1, further comprising a guide formed on a side portion or upper side portion of the outlet collector.

9. The fixed bed reactor of claim 8, wherein the guide includes an opening located between the lower baffle and the outlet collector.

10. The fixed bed reactor of claim 9, wherein the guide has a shape in which a diameter thereof becomes wider as it goes downward from the opening.

11. The fixed bed reactor of claim 1, wherein the fixed bed includes a desulfurization catalyst.

12. The fixed bed reactor of claim 11, wherein the desulfurization catalyst includes a catalyst in which molybdenum-based metal or metal including one or more selected from nickel, cobalt, and tungsten and the molybdenum-based metal are supported on a support.

13. The fixed bed reactor of claim 12, wherein the support contains at least one selected from the group consisting of alumina, silica, silica-alumina, titanium oxide, molecular sieve, zirconia, aluminum phosphate, carbon, and niobia.

14. The fixed bed reactor of claim 1, wherein the outlet collector includes a mesh.

15. A fixed bed reactor for desulfurization atmospheric residue or vacuum residue obtained from a crude distillation unit or a vacuum distillation unit, the fixed bed reactor comprising:
an outlet collector that is located at a lower end portion of the fixed bed reactor; and
a lower baffle spaced apart from an upper portion of the outlet collector;
a guide formed on a side portion or upper side portion of the outlet collector, the guide including an opening located between the lower baffle and the outlet collector; and
a desulfurization catalyst.
